(19) United States
(12) Patent Application Publication
(10) Pub. No.: US 2005/0264168 A1
(43) Pub. Date: Dec. 1, 2005

(54) Electron emission device and manufacturing method of the same

(76) Inventor: Soo-Joung Lee, Suwon-si (KR)

Correspondence Address: CHRISTIE, PARKER & HALE, LLP, PO BOX 7068, PASADENA, CA, 91109-7068, US

(21) Appl. No.: 11/139,048

(22) Filed: May 27, 2005

(30) Foreign Application Priority Data
May 31, 2004 (KR) 10-2004-0039042

(51) Int. Cl. H01J 1/62

(52) U.S. Cl. 313/496

(57) ABSTRACT

The present invention relates to an electron emission device including a light-emitting area having a high level of brightness and conductance and a method of manufacturing the same. An electron emission device according to one embodiment of the present invention comprises a light-emitting region which comprises at least one phosphor layer formed on the second substrate; a surface treatment layer which is formed on the surface of the phosphor layer and comprises a functional material which remains after a firing process for making the phosphor layer; and at least one anode covering the surface treatment layer.

### CROSS-REFERENCE TO RELATED APPLICATION

This application claims priority to and the benefit of Korean Patent Application No. 10-2004-0039042 filed on May 31, 2004 in the Korean Intellectual Property Office, the entire disclosure of which is incorporated herein by reference.

### FIELD OF THE INVENTION

The present invention relates to an electron emission device and a method of manufacturing the same, and more particularly, to an electron emission device comprising a light-emitting region having a high level of brightness and conductance, and a method of manufacturing the same.

### BACKGROUND OF THE INVENTION

Generally, electron emission devices include hot or cold cathodes as electron providing sources. Among the known electron emission devices comprising cold cathodes are the field emitter array (FEA) type, the metal-insulator-metal (MIM) type, the metal-insulator-semiconductor (MIS) type, the surface conduction emitter (SCE) type, and the ballistic electron surface emitter (BSE) type.

The above electron emission devices are different in terms of specific structure. However the electron emission devices basically include an electron emission source for emitting electrons in a vacuum vessel, and a light-emitting region comprising phosphor layers facing the electron emission unit to emit light and display desired images.

### SUMMARY OF THE INVENTION

An electron emission device comprises a first substrate having an electron emission region and electrodes controlling electron emission from the region, and a second substrate having a phosphor layer, a black layer for improving contrast of a screen, and an anode for effectively accelerating electrons emitted from the first substrate to the phosphor layer. The anode may be formed as a thin metal film covering the phosphor layer and the black layer, or as a transparent electrode positioned between a light-emitting region including the phosphor layer and a black layer, i.e., on one surface of the second substrate facing a vacuum vessel.

Electrons which are emitted from an electron emission source form an image by colliding against a phosphor layer and emitting light. But some of the electrons may form accumulated charges in the phosphor layer and the accumulated charges can prevent electrons from reaching the phosphor layer. Consequently screen brightness may decrease. In order to improve the surface conductance, it is proposed that the surface of phosphor particles can be treated with a conductive material or a conductive material can be coated on the surface of the phosphor layer. However, these methods necessitate a separate coating process. Furthermore, according to the latter method, because the black layer is coated with a conductive material even though it does not normally need surface treatment, the improvement in brightness is limited.

According to certain embodiments of the present invention, an electron emission device and manufacturing method of the same are provided wherein a surface treatment of the phosphor layer is formed by a simple process and only the phosphor layer is treated.

In one exemplary embodiment of the present invention, an electron emission device includes first and second substrates facing each other and forming a vacuum vessel; an electron emission unit formed on the first substrate; and a light-emitting region formed on the second substrate. The light-emitting region includes at least one phosphor layer formed on the second substrate; a surface treatment layer which is formed on the surface of the phosphor layer and includes a functional material that remains after a firing process for making the phosphor layer; and at least one anode covering the surface treatment layer.

In another exemplary embodiment of the present invention, an electron emission device includes first and second substrates facing each other and forming a vacuum vessel; an electron emission unit formed on the first substrate; and a light-emitting region formed on the second substrate. The light-emitting region includes at least one anode formed on the second substrate; at least one phosphor layer formed on the anode; and a surface treatment layer which is formed on a surface of the phosphor layer and includes a functional material remaining after a firing process for making the phosphor layer; and at least one thin metal film covering the surface treatment layer.

In yet another embodiment of the present invention, a method of manufacturing an electron emission device includes the steps of: forming at least one phosphor layer on a second substrate corresponding to light-emitting regions defined on the second substrate; surface-treating the phosphor layer by coating a composition for forming an intermediate layer including a functional material which remains on the surface of the phosphor layer after a firing process for making the phosphor layer; forming an anode consisting of thin metal film on the surface-treated phosphor layer; and forming a surface treatment layer by firing the second substrate.

In yet another embodiment of the present invention, a method of manufacturing an electron emission device includes the steps of: forming an anode by coating a transparent oxide on a second substrate corresponding to light-emitting regions defined on the second substrate; forming at least one phosphor layer on the anode; surface-treating the phosphor layer by coating a composition for forming an intermediate layer including a functional material which remains on the surface of the phosphor layer after a firing process for making the phosphor layer; forming a thin metal film on the surface-treated phosphor layer; and forming a surface treatment layer by firing the second substrate.

### BRIEF DESCRIPTION OF THE DRAWINGS

The above and other advantages of the present invention will become more apparent by describing preferred embodiments thereof in detail with reference to the accompanying drawings, in which:

FIG. 1 is a cross-sectional view of an electron emission device according to one embodiment of the present invention; and

FIG. 2 is a cross-sectional view of an electron emission device according to another embodiment of the present invention.

### DETAILED DESCRIPTION

The present invention will be described more fully hereinafter with reference to the accompanying drawings, in which preferred embodiments of the invention are shown.

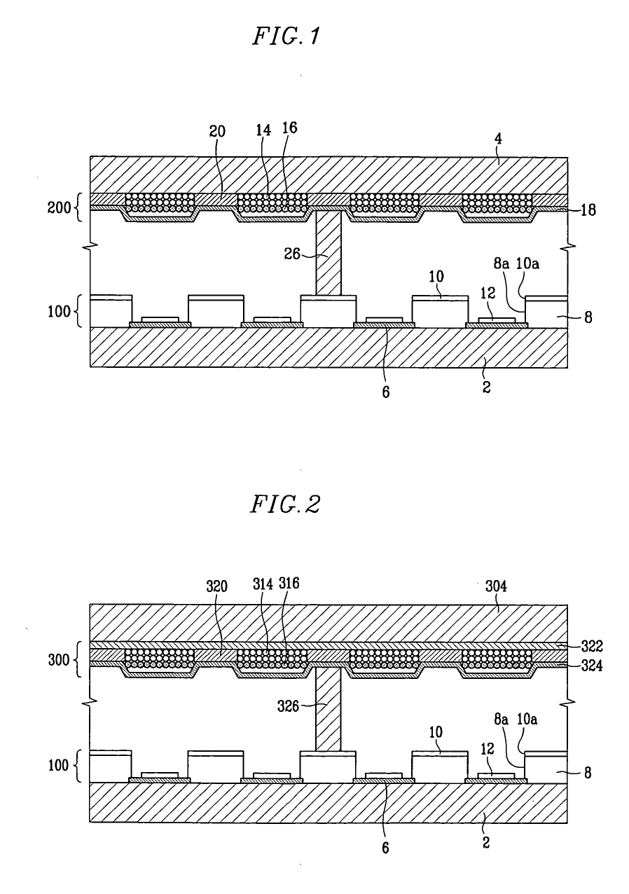

FIG. 1 is a cross-sectional view of an electron emission device according to a first embodiment of the present invention. As shown in FIG. 1, the electron emission device comprises a vacuum vessel constructed of a first substrate 2 and a second substrate 4 sealed to each other while being substantially parallel to one another and spaced from one another by a predetermined distance.

An electron emission unit 100 of the first substrate 2 emits electrons towards the second substrate 4, and a light-emitting region 200 of the second substrate 4 emits visible light to display an image.

The electron emission unit 100 is applied to any known construction of an electron emission device. In FIG. 1, an FEA electron emission device is provided as one example.

As shown in the electron emission device of FIG. 1, a plurality of cathodes 6 are formed in a predetermined pattern, for example in a stripe pattern with a certain gap between each other on the first substrate 2, and an insulating layer 8 is formed covering the cathodes 6. On the insulating layer 8, a plurality of gate electrodes 10 having a predetermined pattern, for example a stripe pattern, are formed in a direction perpendicular to the cathodes 6, with a certain gap between each other.

As shown in FIG. 1, an area where the cathodes 6 and gate electrodes 10 cross is defined as a pixel area, an insulating layer with at least one opening 8a, 10a is formed for each pixel area in the insulating layer 8 and gate electrode 10, and thus some part of the surface of the cathodes 6 is exposed and the electron emission region 12 is formed on the exposed cathodes 6.

The electron emission region 12 includes an electron emitting material which emits electrons when an electric field is applied. Examples include carbon nanotubes, graphite, diamond, diamond-like carbon, fullerene (C60), silicon nanowire, or combinations thereof, or a metal material such as molybdenum. The electron emission region is formed by a method such as screen printing, photolithography, chemical vapor deposition (CVD), sputtering, and so on.

A scan signal is applied to either electrode of the cathode 6 and the gate electrode 10, and a data signal is applied to the other electrode. An electric field is generated around the electron emission source 12 in the pixels having a voltage difference between the two electrodes of more than a threshold voltage, and thus electrons are emitted.

According to the invention, the constitution of the electron emission unit 100 is not limited to the aforementioned embodiment. For example, the gate electrode may first be formed on the first substrate and the cathode may then be formed on the gate electrode, with an insulating layer between the cathode and gate electrodes. The electron emission region is electrically connected with the cathode.

In FIG. 1, the electron emission unit of the FEA electron emission device is illustrated as one example of an electron emission unit. However, the electron emission unit 100 is not limited thereto, and electron emission units of SCE, MIN, MIS, and BSE electron emission devices can be applied.

At least one phosphor layer 14 is formed at one side of the second substrate 4 facing the first substrate 2. A surface treatment layer 16 including a functional material for improving brightness and conductance of the phosphor layer is formed on the phosphor layer 14. At least one anode 18 is formed on the entire surface treatment layer 16 to constitute a light-emitting region 200.

A black layer 20 is preferably formed at the non-light-emitting areas between the phosphor layers 14 for heightening the screen contrast. The black layer 20 may be formed with a thin film such as a chrome oxide thin film, or with a thick film of a carbonaceous material such as graphite.

The anode 18 is preferably formed with a thin metal film which is formed by vapor deposition or sputtering of a metal. A thin aluminum film is the most preferable. The thin metal film is used as an anode when a high voltage is applied to accelerate the electron beam.

A surface treatment layer 16 formed on the phosphor layer 14 includes a functional material which remains after firing. The functional material also plays a role as a passivation layer for preventing deterioration of the phosphor layer due to the electron beam. The surface treatment layer may be formed only on the surface of a certain phosphor layer of R, G, and B phosphors.

The functional material includes a metal- or non-metal-containing oxide, or gelatin. Specific examples are In₂O₃, WO₃, SiO₂, MgO, Y₂(SiO₃)₃, Al₂O₃, Ca₂P₂O₇, SiO₄, and mixtures thereof. When forming a thin metal film of the anode 18, the surface treatment layer 16 is formed by adding the functional material to a composition for forming a intermediate layer which flattens the surface on the phosphor layer 18, coating it on the phosphor layer 14, and forming a thin metal film, followed by firing the second substrate. After firing, only functional material remains on the surface of the phosphor layer 14.

The coating process of the composition for forming an intermediate layer is performed by a method of screen printing, spin coating, and so on, but is not limited thereto. A drying process is preferably performed after coating the composition for forming an intermediate layer. The firing process is preferably performed at a temperature of 200° C. to 500° C.

The composition for forming an intermediate layer is prepared by adding the functional material which can remain after firing the phosphor layer, to a composition for forming a surface flattening layer. The composition includes cellulose resin or acryl resin mixed with an organic solvent. The amount of the functional material which is added to the composition for forming an intermediate layer is 0.001 to 20 parts by weight, preferably 0.01 to 10 parts by weight, more preferably 0.1 to 5 parts by weight, and much more preferably 0.1 to 1 parts by weight with respect to 100 parts by weight of the phosphor layer. When the functional material is included in an amount of less than 0.001 parts by weight, the surface treatment effect cannot be expected, and when its amount is more than 20 parts by weight, the screen brightness is undesirably deteriorated since the transmittance of the visible light decreases. According to an embodiment of the present invention, the surface treatment layer is formed by adding only the functional material to the composition for forming an intermediate layer for forming a surface flattening layer. Therefore, the process of making the surface flattening layer and the surface treatment layer can be preformed at the same time, and there is no benefit to a separate process of making the surface treatment layer. The surface treatment layer can optionally be formed only on the phosphor layer, and it is economical to form the surface treatment layer as a very thin film. It is preferable that the surface treatment layer has a thickness of 1 nm to 10 μm.

The peripheries of the first substrate 2 including the electron emission unit 100, and the second substrate 4 including the light-emitting region 200 are sealed to each other by a sealant after spacers 26 are arranged on the insulating layer. The internal space surrounded by the first and the second substrates is exhausted through an exhaust hole (not shown), thereby completing an electron emission device.

FIG. 2 is a cross-sectional view of an electron emission device according to a second preferred embodiment of the present invention. The electron emission device according to the embodiment has an electron emitting region 400 and light-emitting region 300 similar to those of the first embodiment.

As shown in FIG. 2, the light-emitting region 300 of the electron emission device according to the second embodiment of the present invention includes at least one transparent electrode 322 formed on the second substrate 304; at least one phosphor layer 314 formed on the anode 322; a surface treatment layer 316 which is formed on the phosphor layer 314 and includes the functional material which remains after firing of the phosphor layer; and at least one thin metal film 324 formed covering the surface treatment layer 316.

The light-emitting region 300 has the transparent electrode 322 placed between the phosphor layer 314 and the second substrate 304. The transparent electrode 322 is formed using a transparent oxide, for example Indium Tin Oxide (ITO). The transparent electrode 322 is formed on the entire surface of the second substrate 304 or is formed with various shapes, for example in a stripe pattern.

In the second embodiment, the electron emission device is different from the first embodiment in that the voltage for accelerating the electron beam is supplied to a transparent electrode 322 which functions as an anode, and a thin metal film 324 heightens the screen brightness by the metal back effect.

The black layer 320 for heightening the screen contrast is preferably placed on the non-light-emitting areas between the phosphor layers 314 on the light-emitting areas. The phosphor layer 314 can be formed on the patterned anode 322.

The peripheries of the first substrate 302 including the electron emission unit 400, and the second substrate 304 including the light-emitting region 300 are sealed to each other by a sealant after spacers 326 are arranged on the insulating layer, and the internal space surrounded by the first and the second substrates is exhausted through an exhaust hole (not shown), thereby completing an electron emission device.

The following examples illustrate the present invention in further detail. However, it is understood that the present invention is not limited by these examples.

### EXAMPLES 1 THROUGH 4

Compositions for forming intermediate layers were prepared by adding In₂O₃ to a metal oxide in the amounts shown in Table 1 to a composition for forming an intermediate layer wherein acryl resin was added to terpineol. In Table 1, the amount of the In₂O₃ is based on 100 parts by weight of the phosphor. For each example, the composition was coated on the phosphor layer on the first substrate having a structure according to FIG. 1, and a thin metal film was formed on the phosphor layer by depositing aluminum. Then a metal oxide-containing surface treatment layer was formed by firing at a temperature of 450° C. to remove the acryl emulsion. A second substrate having an electron emission unit as shown in FIG. 1 and the above fabricated first substrate were sealed to each other with a sealant, and the internal space surrounded by the first and the second substrate was exhausted through an exhaust hole, thereby completing an electron emission device.

### COMPARATIVE EXAMPLE 1

An electron emission device was prepared by the same method as Example 1, except that metal oxide was not added to the composition.

Table 1 shows the measurement results of brightness of the electron emission devices according to Examples 1 through 4 and Comparative Example 1.

TABLE 1

| | In₂O₃ (parts by weight) | Relative brightness (%) |
|---|---|---|
| Example 1 | 0.01 | 72 |
| Example 2 | 0.05 | 75 |
| Example 3 | 0.1 | 78 |
| Example 4 | 0.5 | 82 |
| Comparative | — | 63 |
| Example 1 | | |

As shown in Table 1, the brightness of the electron emission devices having a surface treatment layer comprising an oxide of a functional material according to Examples 1 and 4 was high compared with that of Comparative Example 1.

According to the present invention, the surface treatment layer is formed by adding a functional material for improving brightness and conductance of the phosphor layer to the composition, forming an intermediate layer which flattens the surface when forming a thin metal film. Therefore, there is no need to have a separate process for making the surface treatment layer, resulting in a simplified manufacturing process of the electron emission device. The surface treatment can be optionally formed only on the light-emitting region, and it is also economical forming that the surface treatment layer can be formed with a very thin film.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

1. An electron emission device comprising:
a first substrate and a second substrate facing each other and forming a vacuum vessel;
an electron emission unit provided on the first substrate;
a light-emitting region provided on the second substrate and comprising at least one phosphor formed on the second substrate;
a surface treatment layer on the phosphor layer and comprising a functional material which remains after a firing process for making the phosphor layer; and
at least one anode covering the surface treatment layer.

2. The electron emission device of claim 1, wherein a black layer is in the non-emitting area between the phosphor layers.

3. The electron emission device of claim 1, wherein the functional material is an oxide comprising a non-metal or a metal, or gelatin.

4. The electron emission device of claim 3, wherein the oxide is selected from the group consisting of In₂O₃, WO₃, SiO₂, MgO, Y₂(SiO₃)₃, Al₂O₃, Ca₂P₂O₇, SiO₄, and mixtures thereof.

5. The electron emission device of claim 1, wherein the surface treatment layer is formed by coating a composition for forming a intermediate layer which is prepared by adding a functional material to a composition for flattening the surface of the phosphor, on the phosphor layer, and firing.

6. The electron emission device of claim 1, wherein the functional material is present in an amount of 0.001 to 20 parts by weight with respect to 100 parts by weight of the phosphor layer.

7. The electron emission device of claim 6, wherein the functional material is present in an amount of 0.1 to 1 parts by weight with respect to 100 parts by weight of the phosphor layer.

8. The electron emission device of claim 1, wherein the surface treatment layer has a thickness of 1 nm to 10 μm.

9. The electron emission device of claim 1, wherein the anode comprises a thin metal film.

10. The electron emission device of claim 9, wherein the thin metal film is a thin aluminum film.

11. An electron emission device comprising:
a first and a second substrate facing each other and forming a vacuum vessel;
an electron emission unit provided on the first substrate;
a light-emitting region provided on the second substrate and comprising at least one anode on the second substrate;
at least one phosphor layer formed on the anode;
a surface treatment layer on the phosphor layer and comprising a functional material which remains after a firing process for making the phosphor layer; and
at least one thin metal film covering the surface treatment layer.

12. The electron emission device of claim 11, wherein the anode is formed with a transparent electrode.

13. The electron emission device of claim 12, wherein the transparent electrode comprises Indium Tin Oxide (ITO).

14. The electron emission device of claim 11, wherein at least one black layer is on a non-emitting area between the phosphor layers.

15. The electron emission device of claim 11, wherein the functional material is an oxide comprising a non-metal or a metal, or gelatin.

16. The electron emission device of claim 15, wherein the oxide is selected from the group consisting of In₂O₃, WO₃, SiO₂, MgO, Y₂(SiO₃)₃, Al₂O₃, Ca₂P₂O₇, SiO₄, and mixtures thereof.

17. The electron emission device of claim 11, wherein the surface treatment layer is formed by coating a composition for forming an intermediate layer which is prepared by adding a functional material to a composition for flattening the surface of the phosphor, on the phosphor layer, and firing.

18. The electron emission device of claim 11, wherein the functional material is present in an amount of 0.001 to 20 parts by weight with respect to 100 parts by weight of the phosphor layer.

19. The electron emission device of claim 18, wherein the functional material is present in an amount of 0.1 to 1 parts by weight with respect to 100 parts by weight of the phosphor layer.

20. The electron emission device of claim 11, wherein the surface treatment layer has a thickness of 1 nm to 10 μm.

21. A method of manufacturing an electron emission device, comprising:
forming at least one phosphor layer on the second substrate, corresponding to light-emitting areas defined on the substrate;
coating a composition for forming an intermediate layer comprising a functional material which remains on the surface of the phosphor layer after a firing process, resulting in surface-treatment of the phosphor layer;
forming at least one anode of a thin metal film on the surface of the surface-treated phosphor layer; and.
forming the surface treatment layer by firing the second substrate.

22. The method of claim 21, wherein the functional material is an oxide comprising a non-metal or a metal, or gelatin.

23. The method of claim 22, wherein the oxide is selected from the group consisting of In₂O₃, WO₃, SiO₂, MgO, Y₂(SiO₃)₃, Al₂O₃, Ca₂P₂O₇, SiO₄, and mixtures thereof.

24. The method of claim 21, wherein the composition for forming an intermediate layer is prepared by adding a functional material to an acrylic resin emulsion.

25. A method of manufacturing an electron emission device, comprising:
forming an anode by coating a transparent oxide on a second substrate, corresponding to the light-emitting areas defined on the substrate;
forming at least one phosphor layer on the anode;
coating a composition for forming an intermediate layer comprising a functional material which remains on the surface of the phosphor layer after a firing process resulting in surface-treatment of the phosphor layer;
forming a thin metal film on the surface of the surface-treated phosphor layer; and
forming the surface treatment layer by firing the second substrate.

26. The method of claim 25, wherein the functional material is an oxide comprising a non-metal or a metal, or gelatin.

27. The method of claim 28, wherein the oxide is selected from the group consisting of In₂O₃, WO₃, SiO₂, MgO, Y₂(SiO₃)₃, Al₂O₃, Ca₂P₂O₇, SiO₄, and mixtures thereof.

28. The method of claim 25, wherein the composition for forming an intermediate layer is prepared by adding a functional material to an acrylic resin emulsion.
